(19) United States
(12) Patent Application Publication
(10) Pub. No.: US 2002/0160635 A1
(43) Pub. Date: Oct. 31, 2002

(54) MOUNTING RACK FOR PRINTED CIRCUIT BOARDS HAVING CENTER TRANSVERSE RAILS CONDUCTIVELY CONNECTED BY A SPRING CONTACT STRIP

(76) Inventors: SIEGFRIED KURRER, NUERNBERG (DE); ERNST BILLENSTEIN, BURGBERNHEIM (DE); KURT-MICHAEL SCHAFFER, ECKENTAL (DE)

Correspondence Address: SUGHRUE MION ZINN MACPEAK & SEAS, 2100 PENNSYLVANIA AVENUE NW, WASHINGTON, DC, 200373213

(21) Appl. No.: 09/309,304

(22) Filed: May 11, 1999

Related U.S. Application Data
(63) Continuation of application No. PCT/DE97/02596, filed on Nov. 7, 1997.

(30) Foreign Application Priority Data
Nov. 11, 1996 (DE) 29619475.1

(51) Int. Cl. H01R 4/66

(52) U.S. Cl. 439/92

(57) ABSTRACT

A mounting rack contains at least two center transverse rails (16, 20) whose rear faces rest facing one another and which are arranged in the region of the front face and/or rear face (25) of the mounting rack. A spring contact strip (1) is fitted on an inner face (26) of at least one of the two center transverse rails (16, 20) which faces away from the front face or rear face (25) of the mounting rack. The spring contact strip (1) has elongated, angled contact tongues (2) which extend into a gap (19) between the rear faces of the two center transverse rails (16, 20).

This is a Continuation of International Application PCT/DE97/02596, with an international filing date of Nov. 7, 1997, the disclosure of which is incorporated into this application by reference.

### FIELD OF AND BACKGROUND OF THE INVENTION

The invention relates to new and useful improvements to mounting racks for electrical printed circuit boards. More particularly, the invention relates to mounting racks having at least two center transverse rails and to a spring contact strip configured to be inserted into a gap between the center transverse rails.

In their basic configuration, mounting racks have two sidewall plates that are connected to one another by transverse rails. The front face and rear face of the mounting rack are each formed by a pair of upper and lower transverse rails. Respective pairs of guide rails are latched opposite one another into these transverse rails to form so-called installation slots, into which printed circuit boards can be inserted vertically and parallel alongside one another. The vertical distance between the transverse rails on the front face and rear face of the mounting rack, and thus the overall height, are governed by the edge length of the printed circuit boards to be pushed into the mounting rack.

In practice, printed circuit boards have different edge lengths, and are normally designated single or double height (“Europa format”) printed circuit boards. In some applications, so-called mixed layouts have to be accommodated, with single-height and double-height printed circuit boards being accommodated in the same mounting rack. At least two center transverse rails (whose rear faces rest on one another and which, as a rule, are horizontal) are then positioned in between the normal upper and lower transverse rails, at least over a portion of the front face and rear face of the mounting rack. In such a case, the center transverse rails are, for example, attached to an additional, vertical center separating wall. The full height of the mounting rack is then available on one side of the center separating wall, so that printed circuit boards with, e.g., double edge lengths can be mounted into the guide rails fitted on the upper and lower transverse rail.

On the other side of the center separating wall, the total height of the mounting rack is split by the pair of horizontal center transverse rails. This results in two regions, which are located one above the other and into which printed circuit boards with, e.g., single edge lengths can be pushed. On the one hand, such printed circuit boards can be inserted between the pairs of mutually opposite guide rails which are latched in the upper transverse rail of the mounting rack and which are latched in the upper of the two center transverse rails. On the other hand, additional printed circuit boards can be inserted between the pairs of mutually opposite guide rails which are latched in the lower of the two center transverse rails and which are latched in the lower transverse rail of the mounting rack.

Furthermore, as a rule, printed circuit boards have a front panel composed of an electrically conductive material. The front panels of printed circuit boards which are inserted alongside one another into a mounting rack are conductively connected to one another via spring contact strips. They thus form a shielding cover for the mounting rack and for the printed circuit boards mounted in it. In addition, each printed circuit board is electrically conductively connected, for example at a lower or upper end face thereof (e.g., via a retaining screw) to the lower and upper transverse rail or to the lower or upper center transverse rail. As a rule, contact is provided at other points on the mounting rack, for electromagnetic shielding purposes. For example, so-called level shielding plates, which cover the top face or lower face of a mounting rack, are thus attached via specially designed spring contact strips to the front and rear transverse rails, on both the upper face and the lower face of the mounting rack.

### OBJECTS OF THE INVENTION

One particular problem that arises as the result of such a construction is to provide electromagnetic shielding for the gap which normally exists between two horizontal center transverse rails whose rear faces are in contact. Since this gap is not covered by the edges of the front panels of printed circuit boards which are inserted into the regions above and below the center transverse rails, so-called contact strips are inserted or bonded into the gap between those two center transverse rails whose rear faces rest on one another, thereby providing so-called front panel shielding. These contact strips may be composed of a metal strip, one longitudinal edge of which has a number of contact teeth that are bent out obliquely. When such a contact strip is inserted into the gap between two center transverse rails, the spring forces applied by the contact teeth may, however, lead to concave widening of the gap, particularly near its center. This in turn leads to constriction of those regions which are located above and underneath the gap, which regions are intended for the insertion of printed circuit boards, which generally have a single, uniform edge length. Printed circuit boards can then be pushed into the mounting rack only under pressure by exerting force against the pinching and friction forces exerted by the guide rails on the edges of the printed circuit boards.

It is therefore an object of the invention to develop a mounting rack providing sufficient electromagnetic contact in the gap between two center transverse rails that are arranged back to back. A further object of the invention is to provide such an arrangement wherein the electromagnetic contact is produced in a relatively simple manner and without the disadvantage of causing the guide rails to bend and form a concave gap.

### SUMMARY OF THE INVENTION

These and other objects are achieved by a mounting rack and a spring contact strip according to the invention. According to one formulation of the invention, a mounting rack as proposed includes at least two center transverse rails having rear faces resting on each other and defining a gap, and having inner faces directed into an interior of the mounting rack. The mounting rack further includes a spring contact strip fitted on the inner face of at least one of the center transverse rails, wherein the spring contact strip includes a plurality of contact tongues which extend into the gap between the rear faces of the two center transverse rails.

### BRIEF DESCRIPTION OF THE DRAWINGS

The invention and further advantageous refinements of the invention according to the features of the dependent claims are explained in more detail below with the aid of diagrammatic, exemplary embodiments in the drawing, in which:

FIG. 1 shows a perspective side view of a detail of one embodiment of a mounting rack provided with two center transverse rails that rest on one another and with a guide rail that is latched onto one of the center transverse rails, and

FIG. 2 shows a perspective side view of a preferred embodiment of a spring contact strip which, in order to make contact to provide electromagnetic shielding, engages in the gap between two center transverse rails which rest on one another.

### DETAILED DESCRIPTION OF THE PREFERRED EMBODIMENTS

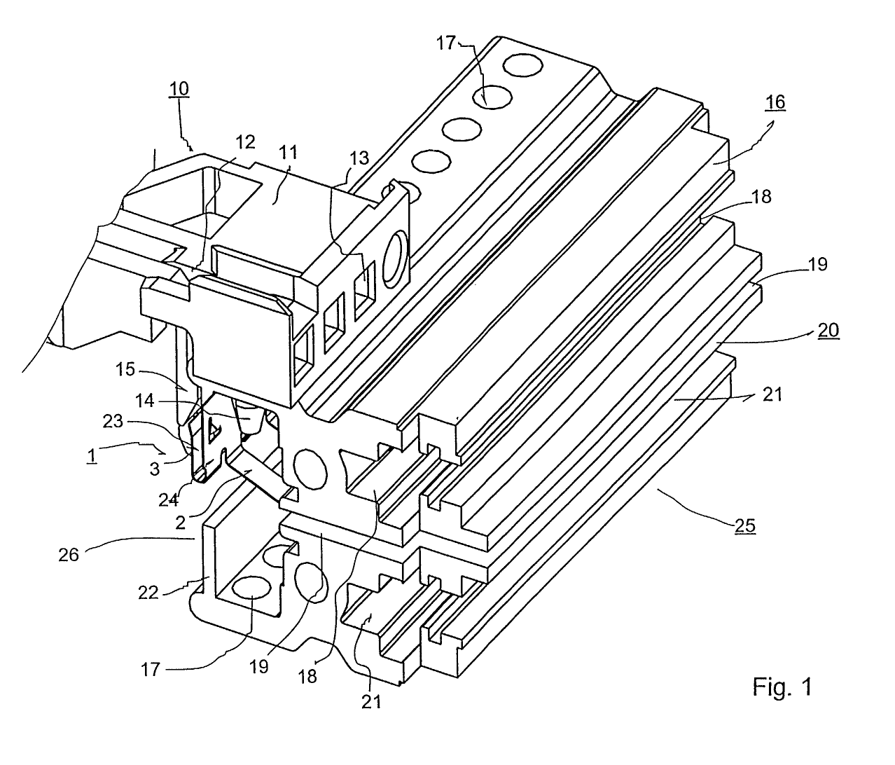

FIG. 1 shows a perspective side view of a mounting rack having at least two horizontal center transverse rails 16 and 20 whose rear faces rest on one another and which are arranged near the front face 25 of the mounting rack. Each of the two center transverse rails 16, 20 has an associated retaining groove 18, 21, respectively, which is open toward the front face 25 and extends transversely across the mounting rack. Threaded rails can be inserted into these retaining grooves, as known in the art. Retaining screws can then engage in these threaded rails, to secure the front panels of the printed circuit boards to the mounting rack.

The top surface of each of the two center transverse rails 16, 20 each has a row of retaining holes 17, into which guide rails for printed circuit boards can be latched. The illustration in FIG. 1 shows the front end piece 11 of such a guide rail 10. Guide studs 14 are provided on the lower face of the end piece 11, and engage with the retaining holes 17 in the upper center transverse rail 16. A latching hook 15 located behind the guide studs 14 engages in the back of a rear longitudinal edge extending along behind the row of retaining holes 17. Together with the guide stud 14, this results in the guide rail 10 being held firmly on the center transverse rail 16. Coding brackets 13, pointing towards the front face 25 of the mounting rack, are arranged on the end face of the end piece 11 of the guide rail 10 in the example in FIG. 1. Appropriate coding pins, which are fitted on the lower edge of the front panels supporting the printed circuit board assemblies, can engage in these coding brackets 13, so that only specific predetermined circuit board assemblies can be fitted into the guide rails 10. The guide rail 10 additionally includes a guide slot 12 configured to receive an edge region of a printed circuit board. In cooperation with another, opposite guide rail, the guide rail 10 thereby holds a mounted circuit board in place within the mounting rack.

According to the invention, a spring contact strip 1 is provided in order to establish electromagnetic contact between the two center transverse rails 16, 20. This spring contact strip 1 is fitted on an inner face 26 of one of the two center transverse rails 16, 20 which faces away from, e.g., the front face (or rear face) of the mounting rack. The spring contact strip has elongated, angled-off contact pins 2, which extend into a gap 19 formed between the rear faces of the two center transverse rails 16, 20 that rest on one another. As a result, the contact pins 2 establish a conductive contact between the two center transverse rails 16, 20.

Such an arrangement has an advantage in that no continuous materials which increase the height of the overall configuration are inserted in the gap 19 between the two horizontal center transverse rails 16, 20. It is thus far less likely for any concave doming of the gap—and thus bending of the center transverse rails—to occur. In fact, the continuous main part of the spring contact strip 1 is fitted in the back 26 of the two center transverse rails 16, 20, and thus not in the gap. Only those contact tongues which are spread away from the main part of the spring contact strip extend into the gap 19 itself. Moreover, by virtue of their length, these contact tongues 2 have a soft spring characteristic. As a result, the load on the gap from materials which could otherwise bend the center transverse rails is thus very low. On the other hand, the arrangement according to the invention ensures virtually completely continuous electromagnetic contact over the entire gap, thus ensuring good electromagnetic shielding.

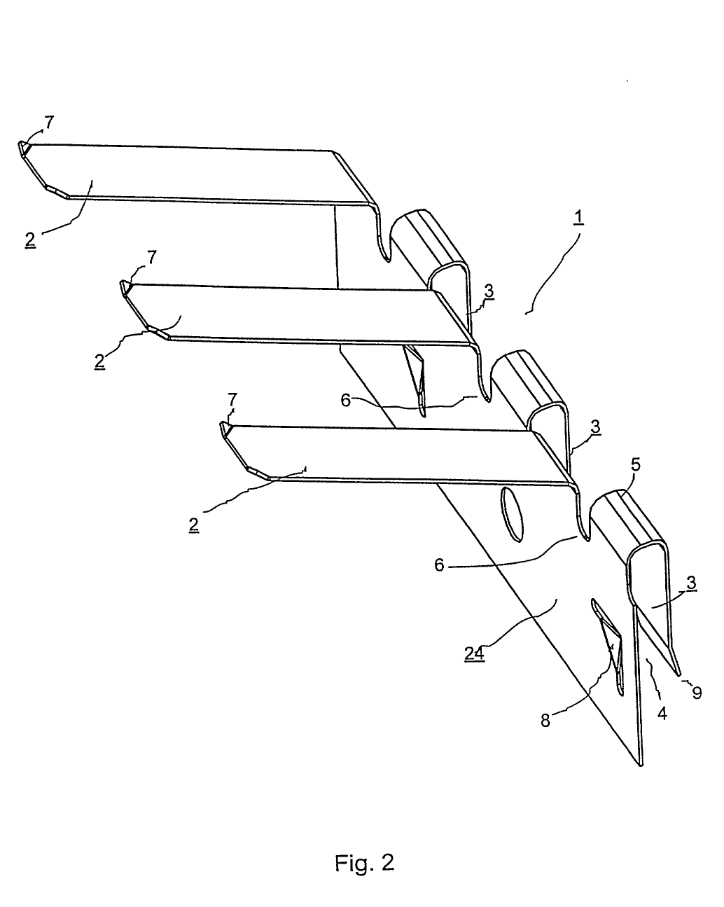

A particularly advantageous design of the spring contact strip 1 according to the invention is shown in FIG. 2. In this embodiment, there is a continuous retaining strip 24, which fulfills a main load-bearing function. The elongated contact tongues 2 extend out to one side from this retaining strip 24, with bracket-like clamping blades 3 being bent in the opposite direction. The clamping blades 3 are advantageously bent through 180° around the head regions 5 thereof, so that the clamping blades 3 are arranged parallel to the retaining strip 24. The clamping blades 3 form a clamping region 4 together with the continuous retaining strip 24. The spring contact strip 1 can be plugged onto the rear face 26 of either of the two center transverse rails 16, 20, by means of this clamping region 4.

In the example shown in FIG. 1, the two horizontal center transverse rails 16, 20 whose rear faces rest on one another each have (on the inner face 26 which faces away from the front face 25 of the mounting rack) a longitudinally extending mounting edge 23, 22, which is located underneath the row of retaining holes 17. In the illustrated example, the spring contact strip 1 is plugged, by its clamping region 4, onto the longitudinally extending mounting edge 23 of the upper center transverse rail 16. The retaining strip 24 of the spring contact strip thus rests on one side of the mounting edge 23, while the clamping blades 3 of the spring contact strip rest on its other side. According to alternative embodiments, which are not illustrated, a spring contact strip 1 can be plugged additionally or instead onto the lower center transverse rail 20. One important feature is that the elongated contact tongues 2 which originate from the spring contact strip 1 extend into the gap 19 and make contact with the two center transverse rails 16, 20 there.

According to the illustrated embodiment of FIG. 2, the elongated contact tongues 2 on the spring contact strip 1 are preferably spread to one side along the continuous retaining strip 24, and alternate with the bracket-like clamping blades 3, which are bent in the opposite direction. This results, on the one hand, in a good clamping effect being achieved in the clamping region 4 and, on the other hand, in the contact tongues 2 having a soft spring characteristic.

The clamping effect can be further enhanced by gripping corners 8, which can be stamped out from the continuous retaining strip 24 so as to protrude toward and latch onto the mounting edge 23 of the transverse rail. The softness of the spring characteristic of the contact pins 2 can be improved further by means of U-shaped cutouts 6 between the contact tongues 2 and the head regions 5 in the transitions to the clamping blades 3. The contact tongues 2 are advantageously bent so as to form an angle of more than 90 degrees relative to the retaining strip 24. In the illustration of FIG. 2, the spring tongues 2 thus point slightly upward. According to the illustration in FIG. 1, the spring tongues thus extend with a slight incline into the gap 19 between the two center transverse rails 16, 20, and are easily bent. This allows good contact to be made with both inner surfaces of the center transverse rails 16, 20, with the spring characteristic of the contact tongues 2 being optimally utilized. Finally, contact corners 7 are preferably angled off on the end faces of the contact tongues 2. Once again, this allows the contact in the gap 19 to be improved.

The above description of the preferred embodiments has been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A mounting rack, comprising:
at least two center transverse rails having rear faces resting on each other and defining a gap, and having inner faces directed into an interior of the mounting rack; and
a spring contact strip fitted on the inner face of at least one of said center transverse rails, wherein said spring contact strip comprises a plurality of contact tongues which extend into the gap between the rear faces of said two center transverse rails.

2. The mounting rack as claimed in claim 1, wherein:
said center transverse rails are arranged in a region of a front face of the mounting rack, and
the inner faces of said center transverse rails face away from the front face of the mounting rack.

3. The mounting rack as claimed in claim 1, wherein each of said contact tongues extends at an angle away from a main portion of said spring contact strip.

4. The mounting rack as claimed in claim 3, wherein:
each of said contact tongues terminates at a respective distal end of said tongue; and
each of said distal ends comprises contact corners that are angled out of a plane of said tongue.

5. The mounting rack as claimed in claim 1, wherein:
at least one of said center transverse rails comprises a longitudinally extending mounting edge on the inner face of said transverse rail; and
said spring contact strip further comprises:
a continuous retaining strip from which said elongated contact tongues extend; and
a plurality of clamping blades extending from said continuous retaining strip, wherein said clamping blades each form a clamping region together with said continuous retaining strip, for clamping said spring contact strip onto said mounting edge of said transverse rail.

6. The mounting rack as claimed in claim 5, wherein:
said contact tongues alternate with said clamping blades along said continuous retaining strip;
said contact tongues are angled off from said continuous retaining strip in a first direction; and
said clamping blades are bent back to form the clamping region in a direction generally opposite the first direction.

7. A mounting rack, comprising:
an electrically conductive transverse rail;
a further electrically conductive element separated from said transverse rail at at least one location by a gap; and
an electrically conductive spring contact strip; wherein said spring contact strip comprises:
a main body mounted to said transverse rail outside the gap; and
a resilient extension contacting said further element within the gap.

8. The mounting rack as claimed in claim 7, wherein said main body of said spring contact strip comprises:
a base portion; and
a clamping blade; wherein:
said resilient extension is an essentially planar tongue angled out of a plane of said base portion in a first direction; and
said clamping blade is a bracket bent out of the plane of said base portion in a second direction that is essentially opposite to the first direction.

9. A spring contact strip, comprising:
a plurality of spring contact tongues;
a plurality of clamping blades respectively alternating with each of said spring contact tongues; and
a conductive strip interconnecting said spring contact tongues and said clamping blades; wherein:
each said spring contact tongue is an extension angled out from a plane of said conductive strip in a first direction; and
each said clamping blade is an extension bent out from the plane of said conductive strip in a second direction that is essentially opposite to the first direction.
